(19) United States
(12) Patent Application Publication
(10) Pub. No.: US 2007/0211209 A1
(43) Pub. Date: Sep. 13, 2007

(54) Attachment sunglasses capable of attaching to the eyeglasses

(76) Inventor: Pao-Yu Liu, Fongyuan City (TW)

Correspondence Address: PAO-YU LIU, P.O. Box 697, Fongyuan City, Taichung County, 420, TW

(21) Appl. No.: 11/373,193

(22) Filed: Mar. 13, 2006

(51) Int. Cl. G02C 9/00

(52) U.S. Cl. 351/47

(57) ABSTRACT

An attachment sunglasses capable of attaching the eyeglasses includes a non-temple sunglasses attachable to an eyeglasses which has a pair of rimmed lenses connected by a bridge and a pair of temples. The sunglasses has a pair of rimmed colored glasses connected by a hollow interior bridge. The bridge has a hook on central top engageable with the bridge of the eyeglasses, a pair of inverse L-shaped stoppers respectively extending out of the bridge via a pair of passages in two ends of the bridge and a spring bias the stoppers disposed inside the bridge. When attaching the sunglasses to the eyeglasses, except the hook hooked the top of the bridge of the eyeglasses, the pair of stoppers are respectively stopped against an inner edge of the pair of lenses under the bridge.

### BACKGROUND OF THE INVENTION

The present invention relates to the spectacles and more particularly to an attachment sunglasses capable of attaching to the eyeglasses.

It is known that the eyeglasses is very helpful to those people who are nearsightednesses. It not only improves their power of vision, shades the strong light against them, but also prevents the ultraviolet ray toward their eyes and beautifies their faces. If a nearsightedness is walking outdoor under sunshine, he always need a sunglasses to protect his eyes. The sunglasses must has lens of equal degree to his own eyeglasses. So he has to buy a focused sunglasses with him by paying more expenses to solve his problem. However, there is scarcely a degreed sunglasses available in the market. Thus, the opticians provide a non-temple sunglasses which is capable of attaching to the front side of the eyeglasses. This type of sunglasses always adopts the magnets disposed on the bridges of the sunglasses and the eyeglasses in corporation with other fastening means to obtain the attachment of sunglasses to the eyeglasses. Nevertheless, this attachment is not so reliable, but ruins the uniform beautification of the glasses due to the large volume of the magnets.

### SUMMARY OF THE PRESENT INVENTION

The present invention has a main object to provide an attachment sunglasses capable of attaching to the eyeglasses without using the magnet or the clamping plates but adopts a spring stopping mode which provides an easy assembly or disassembly of the sunglasses with the eyeglasses. Besides, the assembly is reliable without breaking off.

Another object of the present invention is to provide an attachment sunglasses capable of attaching to the eyeglasses which is openable and keeps uniform beautification.

Accordingly, the attachment sunglasses capable of attaching the eyeglasses of the present invention comprises a non-temple sunglasses having a pair of rimmed glasses connected together by a hollow interior bridge, at least a hook on the bridge attachable to the bridge of the eyeglasses. It is characterized that there is a spring means disposed inside the bridge of the sunglasses to bias a pair of stoppers which respectively stop against the frame of the eyeglasses or the lens thereof if the lens are rimless.

The present invention will become more fully understood by reference to the following detailed description thereof when read in conjunction with the attached drawings.

### BRIEF DESCRIPTION OF THE DRAWINGS

FIG. 1 is an exploded perspectively of the first embodiment of the attachment sunglasses of the present invention,

FIG. 2 is a sectional view to show the hook of the sunglasses hooked the bridge of the eyeglasses,

FIG. 3 is a sectional view to show the spring means biasing the stoppers inside the bridge of the sunglasses,

FIG. 4 is a sectional view to show the attachment of the sunglasses to the eyeglasses,

FIG. 5 is a perspective view of FIG. 4,

FIG. 6 is a sectional view to show a second embodiment of the present invention,

FIG. 7 is a sectional view of a third embodiment of the present invention,

FIG. 8 is an exploded perspective view to show a fourth embodiment of the present invention, and

FIG. 9 is a plane view to show that the sunglasses of FIG. 8 is openable.

### DETAILED DESCRIPTION OF THE PREFERRED EMBODIMENT

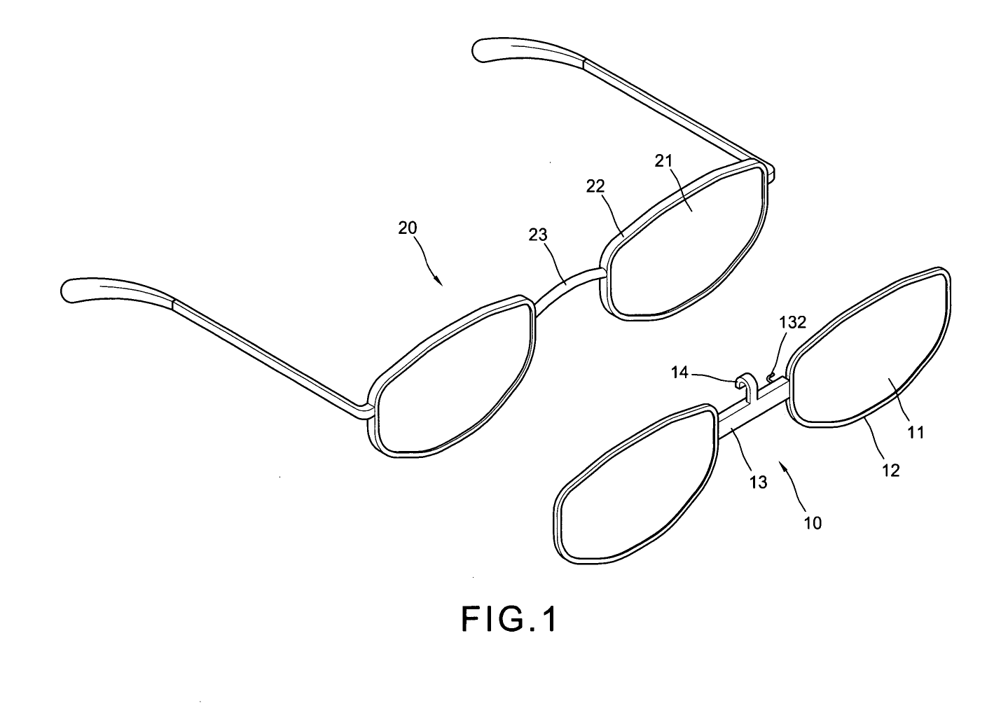

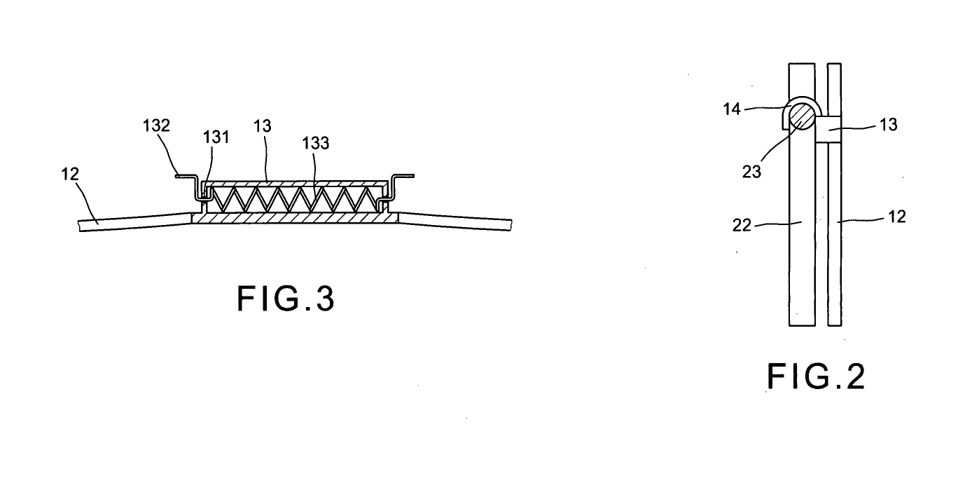

With reference to FIGS. 1-5 of the drawings, the attachment sunglasses of the first embodiment of the present invention comprises a non-temple sunglasses 10 attachable to an eyeglasses 20 which is composed of a pair of lenses 21 in a pair of frames 22 connected on inner edges by a bridge 23 and a pair of temples on outer edges. The attachment sunglasses 10 has a pair of colored glasses 11 in a pair of frames 12 connected by a hollow interior bridge 13, a hook 14 on the central top of the bridge 13, a pair of inverse L-shaped stoppers 131 extending out of the bridge 13 through a pair of passages 131 in two ends of the bridge and biased by a spring means 133 inside the bridge 13.

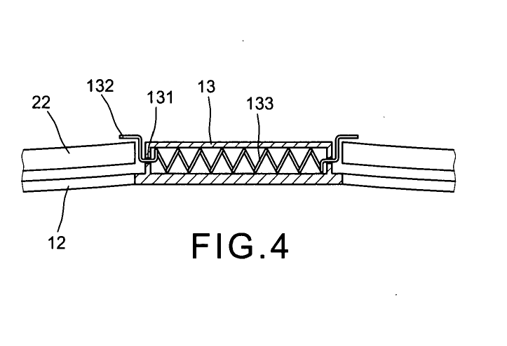

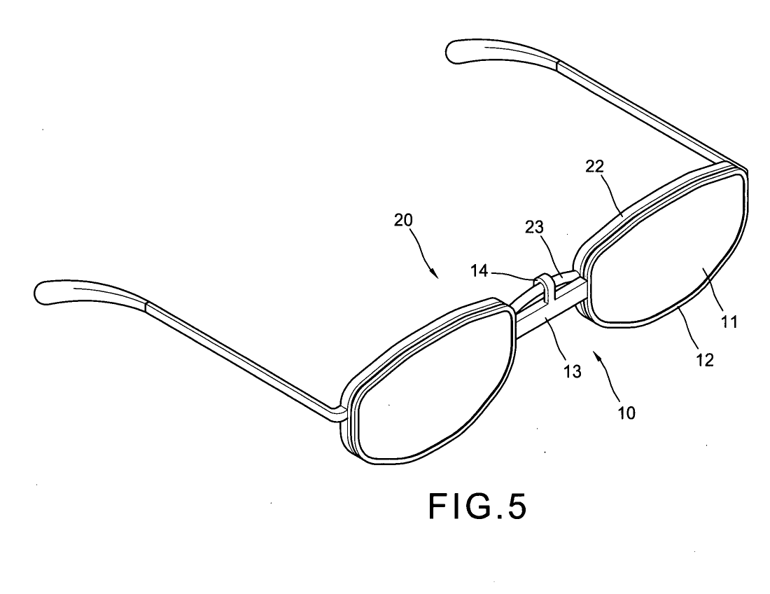

When attach the sunglasses 10 to the eyeglasses 20, slightly tilt the sunglasses to have one of the inverse L-shaped stopper 132 engaged with the inner edge of one of the frames 22 of the eyeglasses 20 under the bridge 23 and press on the frame 22 to enable the other inverse L-shaped stopper 132 engaged with the inner edge of the other frame 22 of the eyeglasses 20, then the hook 14 will be automatically hooked on the top of the bridge 23. So that the sunglasses 10 is lightly attached to the eyeglasses 20 (as shown in FIGS. 4 and 5). When remove the sunglasses 10, do the same process reversely as discussed the above. Both the attachment and the removal actions can be done without removal of the eyeglasses 20 from the wearer's eyes. If the lenses 21 are rimless, one can directly stop the stoppers 132 against the rims of the lenses 21. Due to the three spots engaging arrangement. The attachment of the sunglasses 10 to the eyeglasses 20 should be very tight.

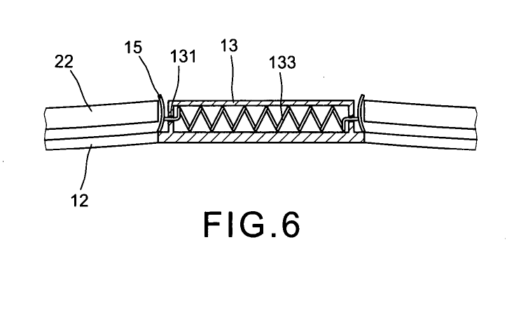

Referring to FIG. 6, a second embodiment of the attachment sunglasses of the present invention is provided. This embodiment is structurally and functionally is similar to the first embodiment and the above discussions is applicable in the most instances. The only modification is done to change the inverse L-shaped stoppers 132 of the above embodiment is replaced with a pair of arcuate stoppers 15 which not only fit to the eyeglasses 20 of the present invention, but also fit to other types of the eyeglasses. Further, the stoppers 15 or 132, except at two ends of the bridge 13, can be positioned at the backside, the underside and/or the top of the bridge 13.

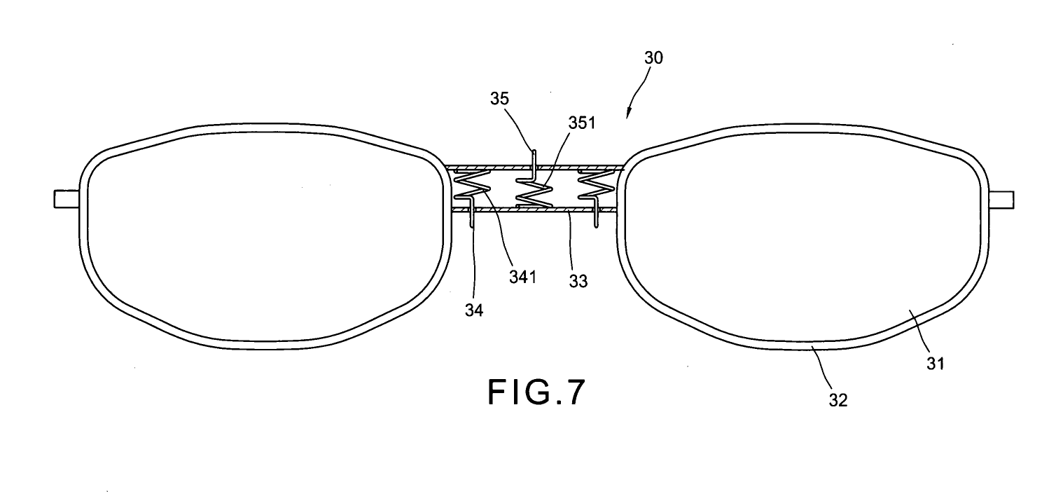

FIG. 7 shows a third embodiment of the non-temple attachment glasses 30 of the present invention which comprises a pair of colored glasses 31 in a pair of frames 32 and connected on inner edges by a hollow interior bridge 33 a top hook 35 extending out through passage in central top, a pair of hooks 34 spacedly extending out through a pair of passages inner the underside of the bridge 33 each of the hooks 34 and 35 are connected to a contractible spring 341 and 351. When attaching, the three hooks 34 and 35 will automatically hook the top and the underside of the bridge of an eyeglasses. Because of the springs 341 and 351 is contractible the hooks 34 and 35 under the contracted force, will be firmly attached to the bridge of an eyeglasses. It is characterized in the easy attachment and easy removal.

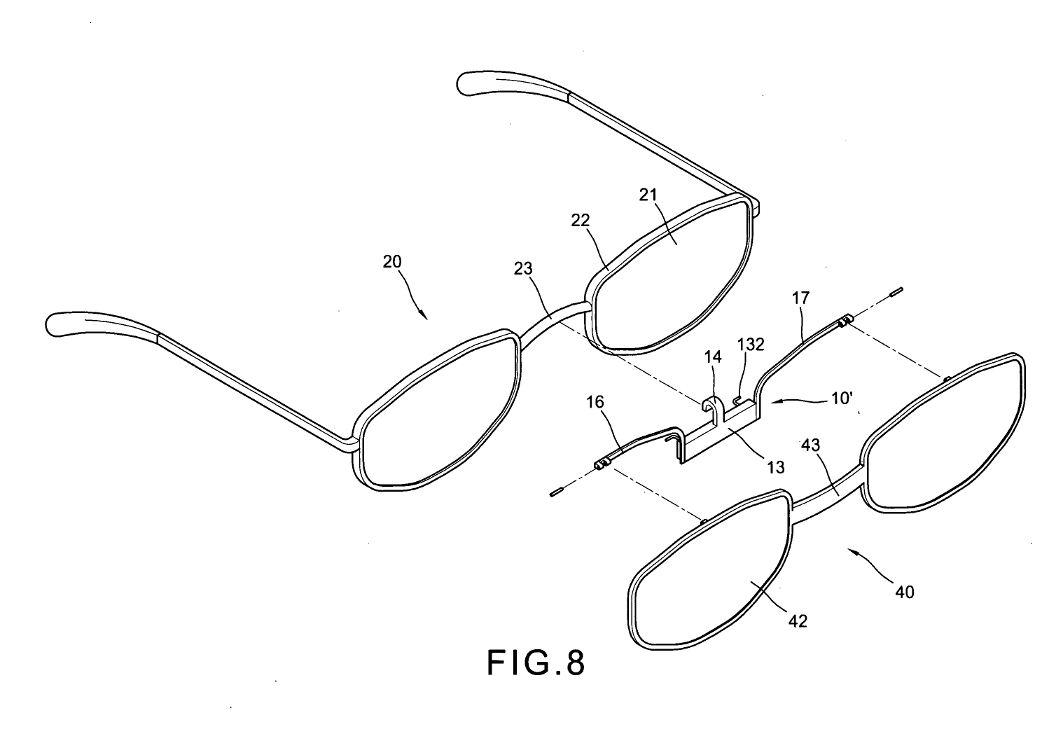

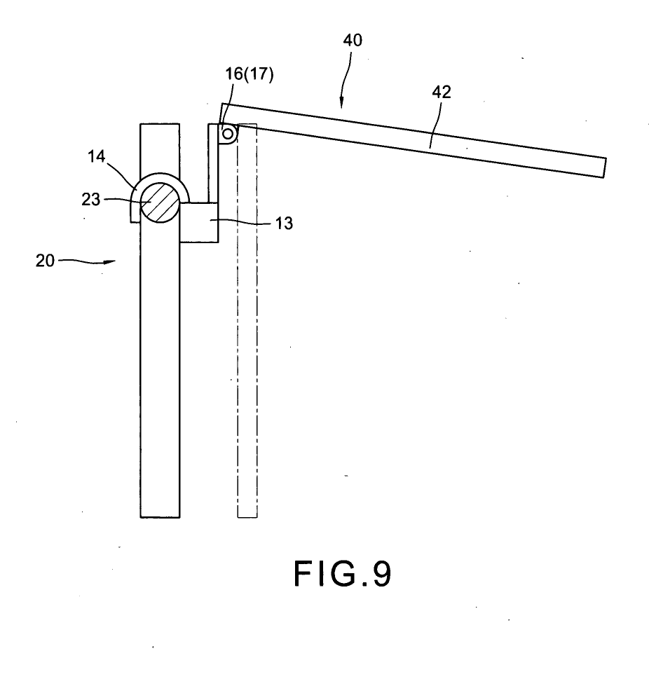

FIGS. 8 and 9 shows a fourth embodiment of the attachment of the present invention. This embodiment includes an eyeglasses 20 equal to that of the first and second embodiment, a sunglasses having a pair of rimmed colored glasses 42 connected by a solid bridge 43. The rimmed glasses 42 each has retaining ring on a central top. A sole attachment device 10′ engaged therebetween. The sole attachment device 10′ includes a hollow interior rectangular box 13, a hook 14, a pair of inverse L-shaped stoppers 132 biased by a spring means 133 (not shown). The structure of the hollow interior rectangular box is equal to the hollow interior bridge 13 of the sunglasses 10 in the first embodiment. But in this embodiment the box 13 has a pair of arms 16 and 17 extended laterally from two ends each has a lug at free end pivoted with the retaining rings on the of the glasses 42. So once the sunglasses 40 is attached to the eyeglasses 20 through the attachment device 10′, the sunglasses 40 is openable on the arms 16 and 17.

Note that the specification relating to the above embodiment should be construed as an exemplary rather than as a limitative of the present invention, with many variations and modifications being readily attainable by a person of average skill in the art without departing from the spirit or scope thereof as defined by the appended claims and their legal equivalents.

I claim:

1. An attachment sunglasses capable of attaching to the eyeglasses comprising:
a non-temple sunglasses attachable to an eyeglasses which is composed of a pair of rimmed lenses connected on inner edge by a bridge and a pair of temples pivoted to an outer edge respectively; said attachment sunglasses having a pair of rimmed colored glasses connected on their inner edges by a hollow interior bridge which has a hook on central top engageable with the bridge of said eyeglasses, a passage in each end for permitting a pair of inverse L-shaped stoppers extending out of the bridge and engageable with an inner edge of the rimmed lenses of said eyeglasses and biased by a spring means inside said hollow interior bridge.

2. The attachment sunglasses as recited in claim 1, wherein said inverse L-shaped stoppers are directly stopped against the lenses if the lenses is rimless.

3. An attachment sunglasses capable of attaching to the eyeglasses comprising:
a non-temple sunglasses attachable to an eyeglasses which is composed of a pair of rimmed lenses connected on inner edge by a bridge and a pair of temples pivoted to an outer edge respectively; side attachment sunglasses having a pair of rimmed colored glasses connected on their inner edges by a hollow interior bridge which has a hook on central top engageable with the bridge of said eyeglasses, a passage in each end for permitting a pair of arcuate stoppers extending of the bridge and engageable with an inner edge of the rimmed lenses of said eyeglasses and biased by a spring means inside said hollow interior bridge.

4. The attachment sunglasses as recited in claim 3, wherein said stopper can be positioned on the top, the underside and/or the backside of the follow interior bridge.

5. An attachment sunglasses capable of attaching to the eyeglasses comprising:
a non-temple sunglasses attachable to a bridge of an eyeglasses and having a pair of rimmed colored glasses connected on their inner edges by a hollow interior bridge which has a first passage in a central top, a pair of second passages spacedly formed in underside for permitting a first hook and a pair of second hooks extending out of the bridge, each of the hooks connected to a contraction spring inside said bridge for providing tension force when the hooks respectively hook a top and an underside of the bridge of said eyeglasses.

6. An attachment sunglasses capable of attaching to the eyeglasses comprising:
an eyeglasses having a pair of rimmed lenses connected on their inner edges by a first bridge and a pair of temples respectively pivoted to their outer edges;
a sunglasses having a pair of rimmed colored glasses connected on their inner edges by a second bridge;
a sole attachment device having a hollow interior rectangular box which has a hook on central top engageable with the first bridge, a pair of inverse L-shaped stoppers extending out of the box via a pair of passages in two ends of said box and biased by a spring means inside said box and engageable with inner edges of said lenses under said first bridge, a pair of arms extending laterally from two ends of said box and each having a lug at free end pivoted to a pair of retaining rings on a central top of said rimmed colored glasses. Thereby, said sunglasses is openable on the pair of arms.
